(19) United States
(12) Patent Application Publication
(10) Pub. No.: US 2025/0246854 A1
(43) Pub. Date: Jul. 31, 2025

(54) ELECTRIC CONNECTOR, CONNECTION ASSEMBLY, AND CABLE

(71) Applicant: SUMITOMO ELECTRIC INDUSTRIES, LTD., Osaka (JP)

(72) Inventors: Shun ENDO, Osaka (JP); Takeshi INOUE, Osaka (JP)

(73) Assignee: SUMITOMO ELECTRIC INDUSTRIES, LTD., Osaka (JP)

(21) Appl. No.: 19/007,869

(22) Filed: Jan. 2, 2025

(30) Foreign Application Priority Data
Jan. 25, 2024 (JP) 2024-009559

(51) Int. Cl. H01R 12/53; H01R 13/6471

(52) U.S. Cl. CPC H01R 13/6474; H01R 13/6471

(57) ABSTRACT

An electric connector includes a cable including a plurality of conductors and a covering portion, the plurality of conductors being arranged side by side and including a plurality of signal lines and a plurality of ground lines, the covering portion being configured to cover the plurality of conductors such that an end portion of each of the plurality of conductors is exposed, and a plurality of terminals arranged side by side along an aligned direction of the plurality of conductors in such a manner that each of the plurality of terminals faces a corresponding one of the end portions of the plurality of ground lines, the plurality of terminals electrically connecting each of the plurality of ground lines to a ground.

### CROSS REFERENCE TO RELATED APPLICATIONS

This application claims priority based on Japanese Patent Application No. 2024-009559 filed on Jan. 25, 2024, and the entire contents of the Japanese patent application are incorporated herein by reference.

### TECHNICAL FIELD

The present disclosure relates to an electric connector, a connection assembly and a cable.

### BACKGROUND ART

Patent literature 1 (Japanese Unexamined Patent Application Publication No. 2010-49971) and patent literature 2 (Japanese Unexamined Patent Application Publication No. 2021-34283) disclose a flat cable including a plurality of conductors and a covering portion covering the plurality of conductors. In the flat cable described in patent literature 1, an end portion of each of the plurality of conductors is exposed from the covering portion.

### SUMMARY OF THE INVENTION

An electric connector of the present disclosure includes a cable including a plurality of conductors and a covering portion, the plurality of conductors being arranged side by side and including a plurality of signal lines and a plurality of ground lines, the covering portion being configured to cover the plurality of conductors such that an end portion of each of the plurality of conductors is exposed, and a plurality of terminals arranged side by side along an aligned direction of the plurality of conductors in such a manner that each of the plurality of terminals faces a corresponding one of the end portions of the plurality of ground lines, the plurality of terminals electrically connecting each of the plurality of ground lines to a ground. In a cross section of the plurality of conductors in a plane perpendicular to a center axis of the plurality of conductors, only the plurality of ground lines among the plurality of signal lines and the plurality of ground lines each include a first flat portion on a surface of each of the plurality of ground lines, and each of the plurality of terminals includes a connecting portion connected to the first flat portion.

### BRIEF DESCRIPTION OF THE DRAWINGS

FIG. 1 is a perspective view of a connection assembly according to an embodiment.

FIG. 2 is a side view of the connection assembly of FIG. 1.

FIG. 3 is a cross-sectional view of the connection assembly taken along line III-III of FIG. 2.

FIG. 4 is a cross-sectional view of the connection assembly taken along line IV-IV of FIG. 2.

FIG. 5A is a cross-sectional view of a cable included in a connection assembly according to a first modification.

FIG. 5B is a cross-sectional view of a cable included in a connection assembly according to a second modification.

### DETAILED DESCRIPTION

In the flat cable as described in patent literature 1, crosstalk that occurs between the plurality of conductors may be a problem. For example, in the flat cable described in patent literature 1, at an end portion of the plurality of conductors, the influence of crosstalk in which a part of electromagnetic waves generated by a signal transmitted to a signal line goes around another signal line through an air layer may be a problem. The occurrence of such crosstalk is a factor of degrading communication performance. The shape of the conductor itself may also affect the communication performance. For example, when a ground line having a circular shape is used as in the flat cable described in patent literature 2, the ground line itself cannot have a sufficient cross-sectional area, and the electrical resistance tends to increase. In this case, it is difficult to improve the communication performance.

The present disclosure provides an electric connector, a connection assembly, and a cable, which can improve communication performance.

### Description of Embodiments of Present Disclosure

First, the contents of embodiments of the present disclosure will be listed and explained.

(1) An electric connector of the present disclosure includes a cable including a plurality of conductors and a covering portion, the plurality of conductors being arranged side by side and including a plurality of signal lines and a plurality of ground lines, the covering portion being configured to cover the plurality of conductors such that an end portion of each of the plurality of conductors is exposed, and a plurality of terminals arranged side by side along an aligned direction of the plurality of conductors in such a manner that each of the plurality of terminals faces a corresponding one of the end portions of the plurality of ground lines, the plurality of terminals electrically connecting each of the plurality of ground lines to a ground. In a cross section of the plurality of conductors in a plane perpendicular to a center axis of the plurality of conductors, only the plurality of ground lines among the plurality of signal lines and the plurality of ground lines each include a first flat portion on a surface of each of the plurality of ground lines, and each of the plurality of terminals includes a connecting portion connected to the first flat portion.

The electric connector includes a plurality of terminals arranged side by side along an aligned direction of the plurality of conductors in such a manner that each of the plurality of terminals faces a corresponding one of the end portions of the plurality of ground lines, and electrically connecting each of the plurality of ground lines to a ground. In this case, it is possible to reduce crosstalk in which a part of an electromagnetic wave generated by a signal transmitted to a signal line goes around another signal line through an air layer. Further, in a cross section of the plurality of conductors in a plane perpendicular to a center axis of the plurality of conductors, only the plurality of ground lines among the plurality of signal lines and the plurality of ground lines each include a first flat portion on a surface of each of the plurality of ground lines. Each of the plurality of terminals includes a connecting portion connected to the first flat portion. When the ground line includes the first flat portion on the surface as described above, the bonding strength between the ground line and the terminal can be improved, and thus the plurality of ground lines can be stably connected to the ground via the plurality of terminals. In addition, when the ground line includes the first flat portion on the surface, the cross-sectional area of the ground line can be increased as compared to when the ground line does not include the first flat portion on the surface (for example, a ground line having a circular shape), thereby reducing electrical resistance. Furthermore, since the signal line does not include the first flat portion on the surface, it is possible to suppress the formation of a corner portion on the surface of the signal line, and thus it is possible to suppress the deterioration of the high-frequency characteristics due to the skin effect. Thus, according to the electric connector, it is possible to improve the communication performance of a signal propagating through a signal line or the like.

(2) In the electric connector according to the above (1), the plurality of signal lines may include a first signal line and a second signal line adjacent to each other. The plurality of ground lines may include a first ground line and a second ground line that are disposed so as to sandwich the first signal line and the second signal line in the aligned direction and are electrically connected to each other via the plurality of terminals. In this case, the first signal line and the second signal line can constitute a differential signal line. Thus, since the currents flowing through the first signal line and the second signal line are in opposite phases, for example, a part of the electromagnetic wave that goes around the first ground line from the first signal line and a part of the electromagnetic wave that goes around the second ground line from the second signal line can be canceled out by each other. As a result, the communication performance of the signal propagating through the signal line or the like can be further improved.

(3) In the electric connector according to (1) or (2), the electric connector may include a conductive member disposed on a surface of or inside the covering portion and connected to the ground. The plurality of ground lines may be connected to the conductive member via the plurality of terminals. In this case, the ground can be stabilized by connecting the plurality of terminals to the conductive member and integrating them. Thus, it is possible to reduce the influence of crosstalk and improve the communication performance of a signal propagating through a signal line or the like.

(4) In the electric connector according to any one of (1) to (3), each of the plurality of ground lines may further include, on the surface, a second flat portion facing away from the first flat portion along a vertical direction perpendicular to the aligned direction in the cross section. For example, when the electric connector is disposed on the main surface of the substrate, the second flat portion of each of the plurality of ground lines is connected to the electrodes of the main surface, thereby improving the bonding strength between the ground line and the terminal in the first flat portion and also improving the bonding strength between the ground line and the electrode of the substrate in the second flat portion. Thus, the electrical connection between the terminal, the ground line, and the electrode of the substrate can be stabilized.

(5) In the electric connector according to any one of (1) to (4), each of the plurality of ground lines may further include, on the surface, a third flat portion and a fourth flat portion that face away from each other along the aligned direction in the cross section of the plurality of conductors in a plane perpendicular to the center axis of the plurality of conductors. In this case, for example, as compared with a case where the ground line includes curved surfaces bulging toward both sides in the aligned direction in the surface, the interval between the ground lines adjacent to each other can be made constant, and thus, the variation in impedance can be suppressed. As a result, it is possible to suppress deterioration of a signal due to the variation in impedance.

(6) In the electric connector according to any one of (1) to (5), in the cross section, when a direction perpendicular to the aligned direction is defined as a vertical direction, a width of the ground line along the vertical direction may be larger than a width of the ground line along the aligned direction. When the cross section of the ground line extends in the vertical direction as described above, the ground line can effectively shield electromagnetic wave that goes around from one signal line to another signal line with the ground line interposed therebetween. Thus, the crosstalk between these signal lines can be reduced. Further, when the cross section of the ground line extends in the vertical direction as described above, the cross-sectional area of the ground line can be increased, and thus an increase in electrical resistance can be suppressed. As a result, the communication performance of the signal propagating through the signal line or the like can be further improved.

(7) In the electric connector according to any one of (1) to (6), each of the plurality of signal lines may have a circular shape in the cross section. In this case, it is possible to more effectively suppress the deterioration of the high-frequency characteristics due to the skin effect in the plurality of signal lines.

(8) A connection assembly according to an aspect of the present disclosure may include the electric connector according to any one of (1) to (7), and a substrate including a plurality of electrodes each connected to a corresponding one of the plurality of conductors, and being provided with the electric connector. Thus, the connection assembly that achieves the effect of (1) can be realized.

(9) A cable according to an aspect of the present disclosure includes a plurality of conductors arranged side by side and including a plurality of signal lines and a plurality of ground lines, and a covering portion configured to cover the plurality of conductors such that an end portion of each of the plurality of conductors is exposed. In a cross section of the plurality of conductors in a plane perpendicular to a center axis of the plurality of conductors, only the plurality of ground lines among the plurality of signal lines and the plurality of ground lines each include a first flat portion on a surface of each of the plurality of ground lines.

In the cable, in the cross section of the plurality of conductors in a plane perpendicular to a center axis of the plurality of conductors, only the plurality of ground lines among the plurality of signal lines and the plurality of ground lines each include the first flat portion on a surface of each of the plurality of ground lines. In this case, when the ground line is bonded to the ground via another conductor, the first flat portion of the ground line is used as a connecting portion with another conductor, thereby improving the bonding strength between the ground line and another conductor. Thus, the plurality of ground lines can be stably connected to the ground via another conductor. In addition, when the ground line includes the first flat portion on the surface, the cross-sectional area of the ground line can be increased as compared to when the ground line does not include the first flat portion on the surface (for example, a ground line having a circular shape), thereby reducing an increase in electrical resistance. Furthermore, since the signal line does not include the first flat portion on the surface, it is possible to suppress the formation of a corner portion on the surface of the signal line, and thus it is possible to suppress the deterioration of the high-frequency characteristics due to the skin effect. Thus, according to the described-above cable, it is possible to improve the communication performance of a signal propagating through a signal line or the like.

(10) In the cable according to (9), the plurality of signal lines may include a first signal line and a second signal line adjacent to each other. The plurality of ground lines may include a first ground line and a second ground line that are disposed so as to sandwich the first signal line and the second signal line in a aligned direction of the plurality of conductors and are electrically connected to each other. In this case, the first signal line and the second signal line can constitute a differential signal line, and thus, the currents flowing through the first signal line and the second signal line are in opposite phases. In this case, when the first ground line and the second ground line are bonded to the ground, for example, a part of the electromagnetic wave that goes around the first ground line from the first signal line and a part of the electromagnetic wave that goes around the second ground line from the second signal line can be canceled out by each other. Thus, since the influence of noise caused by the first signal line and the second signal line can be reduced, the communication performance of signals propagated through the plurality of signal lines can be further improved.

### Details of Embodiments of Present Disclosure

Specific examples of an electric connector, a connection assembly, and a cable of the present disclosure will be described below with reference to the drawings. The present disclosure is not limited to these examples, but is defined by the scope of the claims, and is intended to include all modifications within the meaning and scope equivalent to the scope of the claims. In the following description, the same elements are denoted by the same reference numerals in the description of the drawings, and redundant description will be appropriately omitted.

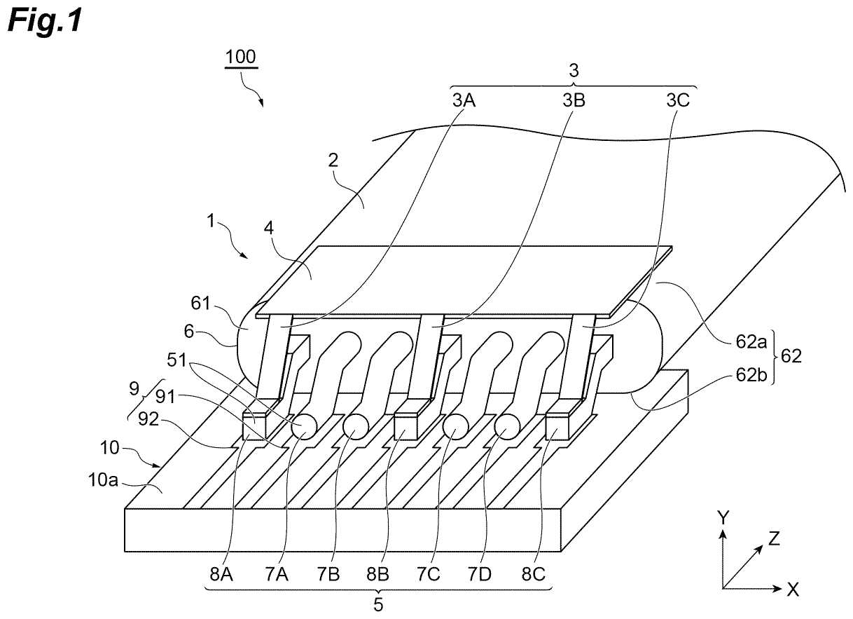

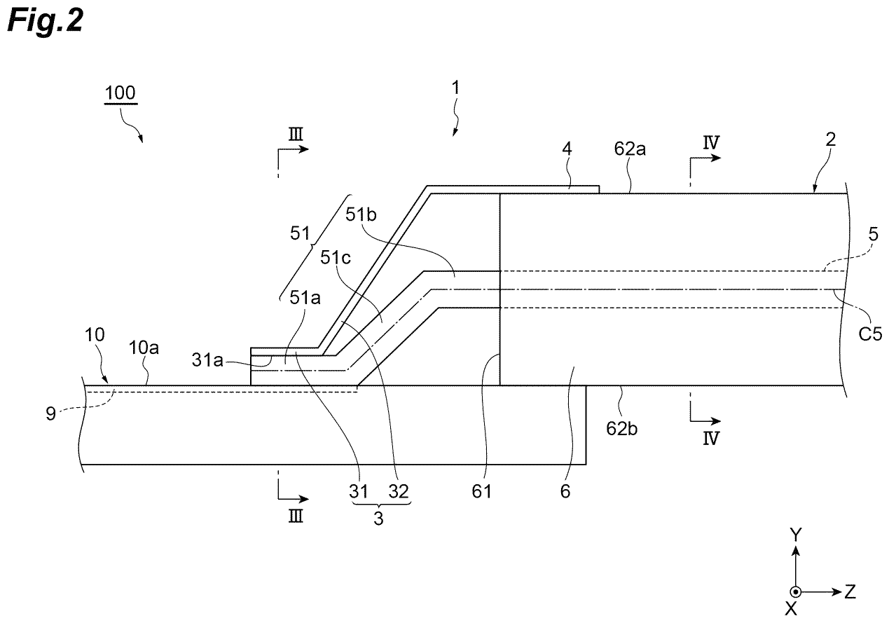

FIG. 1 is a perspective view of a connection assembly according to an embodiment. FIG. 2 is a side view of the connection assembly of FIG. 1. As shown in FIGS. 1 and 2, a connection assembly 100 includes an electric connector 1 and a substrate 10. Electric connector 1 includes a cable 2, a plurality of terminals 3, and a ground bar 4 (conductive member). Hereinafter, the width direction of cable 2 is referred to as an X direction (aligned direction), the height direction of cable 2 is referred to as a Y direction (vertical direction), and a direction orthogonal to the X direction and the Y direction is referred to as a Z direction.

Substrate 10 includes a main surface 10a and a plurality of electrodes 9. Main surface 10a extends along the X direction and the Z direction. Electric connector 1 is disposed so as to face main surface 10a in the Y direction, and is mounted on main surface 10a. The plurality of electrodes 9 are provided on main surface 10a so as to be arranged along the X direction. Each of the plurality of electrodes 9 faces a corresponding one of the plurality of conductors 5 of cable 2 along the Y direction. The plurality of electrodes 9 are each connected to a corresponding one of the plurality of conductors 5. The plurality of electrodes 9 include, for example, a plurality of signal electrodes 91 and a plurality of ground electrodes 92. Each of the plurality of signal electrodes 91 is an electrode used as a signal line. Each of the plurality of ground electrodes 92 is an electrode used as a ground line. In this specification, the term “connect” includes both a mode in which two elements are directly coupled and a mode in which two elements are indirectly coupled via another element.

Cable 2 is, for example, a flexible flat cable (FFC). Cable 2 includes a plurality of conductors 5 and a covering portion 6. Each of the plurality of conductors 5 is a member for transmitting electric power or an electric signal, and is an electric wire formed of a metal such as copper, for example. The plurality of conductors 5 each extend along the Z direction and are arranged along the X direction.

As shown in FIG. 1, the plurality of conductors 5 include, for example, a signal line 7A (first signal line), a signal line 7B (second signal line), a signal line 7C, a signal line 7D, a ground line 8A (first ground line), a ground line 8B (second ground line), and a ground line 8C. Signal line 7A and signal line 7B are adjacent to each other along the X direction. Ground line 8A and ground line 8B are disposed so as to sandwich signal line 7A and signal line 7B in the X direction. Signal line 7C and signal line 7D are adjacent to each other along the X direction. Ground line 8B and ground line 8C are disposed so as to sandwich signal line 7C and signal line 7D in the X direction. Two signal lines 7A and 7B adjacent to each other pass currents in opposite phases to each other, and transmit signals by differential transmission in which signals are transmitted by a potential difference between two signal lines 7A and 7B. Similarly, two signal lines 7C and 7D adjacent to each other pass currents in opposite phases to each other, and transmit signals by differential transmission in which signals are transmitted by a potential difference between two signal lines 7C and 7D.

In the example shown in FIG. 1, ground line 8A, signal line 7A, signal line 7B, ground line 8B, signal line 7C, signal line 7D, and ground line 8C are arranged in this order along the X direction. As described above, cable 2 has a ground signal signal ground (GSSG) structure constituted by ground line 8A, signal line 7A, signal line 7B, and ground line 8B, and the other GSSG structure constituted by ground line 8B, signal line 7C, signal line 7D, and ground line 8C.

Hereinafter, when signal lines 7A to 7D are described without being distinguished from each other, each of signal lines 7A to 7D is simply referred to as a “signal line 7”. Similarly, when ground lines 8A to 8C are described without being distinguished from each other, each of ground lines 8A to 8C is simply referred to as a “ground line 8”. The disposition of each signal line 7 and each ground line 8 is not limited to the above-described example, and may be another disposition.

As shown in FIGS. 1 and 2, covering portion 6 covers the plurality of conductors 5 such that an end portion 51 of each of the plurality of conductors 5 is exposed. Covering portion 6 includes an end face 61 and a surface 62. End face 61 is an end face disposed at the end of covering portion 6 in the Z direction, and extends along the X direction and the Y direction. End portion 51 of each of the plurality of conductors 5 protrude from end face 61 in the Z direction. Surface 62 extends so as to surround the plurality of conductors 5. Surface 62 includes a first surface 62a and a second surface 62b arranged along the Y direction. First surface 62a and second surface 62b extend along the X direction and the Z direction. Second surface 62b faces main surface 10a of substrate 10 in the Z direction. For example, second surface 62b may be in contact with main surface 10a of substrate 10.

End portion 51 of each of the plurality of conductors 5 protruding from end face 61 of covering portion 6 extends to the plurality of electrodes 9 on main surface 10a of substrate 10 while being bent toward the Z direction. As shown in FIG. 2, for example, end portion 51 extends from end face 61 along the Z direction, and then extends in a direction inclined with respect to the Z direction so as to be directed toward electrode 9 of main surface 10a.

End portion 51 includes, for example, a first portion 51a, a second portion 51b, and a coupled portion 51c. Second portion 51b extends from end face 61 of covering portion 6 along the Z direction. Coupled portion 51c forms a bend with respect to second portion 51b, and extends, for example, in a direction inclined with respect to both the Y direction and the Z direction when viewed along the X direction. First portion 51a extends from coupled portion 51c to the end surface of conductor 5. First portion 51a extends from coupled portion 51c along the Z direction and is connected to electrode 9 of substrate 10.

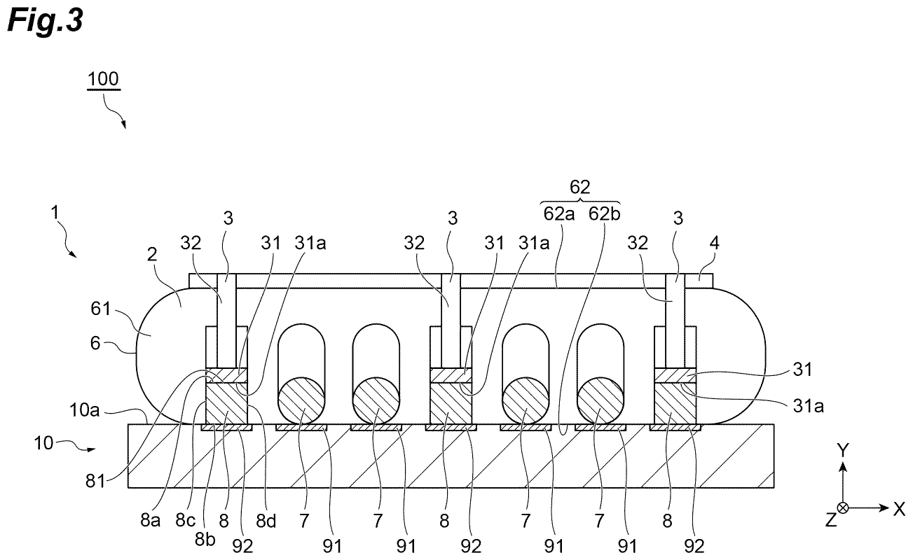

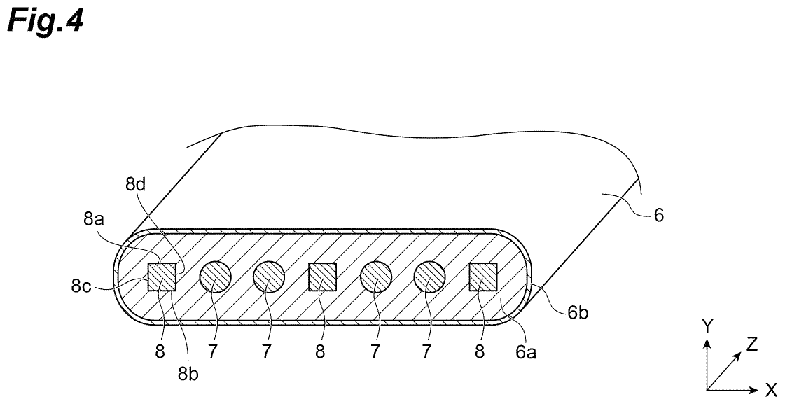

FIG. 3 is a cross-sectional view of the connection assembly taken along line III-III of FIG. 2. FIG. 4 is a cross-sectional view of the connection assembly taken along line IV-IV of FIG. 2. As shown in FIG. 4, covering portion 6 includes an insulating portion 6a and a shield layer 6b surrounding insulating portion 6a. Insulating portion 6a extends along the Z direction. The plurality of signal lines 7 and the plurality of ground lines 8 are disposed inside insulating portion 6a. Shield layer 6b is disposed so as to surround insulating portion 6a with the Z direction as the center. As a material of shield layer 6b, for example, a metal (for example, copper or aluminum foil) can be used. As an example, shield layer 6b is an aluminum tape. Shield layer 6b is electrically connected to the ground. The surface of shield layer 6b constitutes surface 62 of covering portion 6 including first surface 62a and second surface 62b. Shield layer 6b is disposed on cable 2, thereby reducing the influence of noise from the outside of cable 2.

As shown in FIGS. 1 and 3, ground bar 4 is located on the opposite side of substrate 10 in the Y direction with respect to cable 2. Ground bar 4 is disposed on, for example, first surface 62a of covering portion 6. Ground bar 4 is, for example, a plate-like conductive member extending along the X direction and the Z direction. Ground bar 4 has a rectangular shape having the X direction as a longitudinal direction when viewed along the Y direction. Ground bar 4 is in contact with first surface 62a of covering portion 6 and is electrically connected to shield layer 6b. Ground bar 4 may be disposed inside covering portion 6 (for example, inside insulating portion 6a).

A plurality of terminals 3 are arranged side by side along the X direction in such a manner that each of the plurality of terminals 3 faces a corresponding one of end portions 51 of the plurality of ground lines 8. The plurality of terminals 3 electrically connect the plurality of ground lines 8 to the ground via ground bar 4. As shown in FIG. 1, the plurality of terminals 3 include a terminal 3A, a terminal 3B, and a terminal 3C. For example, terminal 3A, terminal 3B, and terminal 3C respectively face ground line 8A, ground line 8B, and ground line 8C along the Y direction, and are respectively electrically connected to ground line 8A, ground line 8B, and ground line 8C. Hereinafter, when terminals 3A to 3C are described without being distinguished from each other, each of terminals 3A to 3C is simply referred to as “terminal 3”.

As shown in FIG. 2, each of the plurality of terminals 3 has an end portion 31 and a coupled portion 32. End portion 31 of terminal 3 includes a connection surface 31a (connecting portion) connected to first portion 51a of end portion 51 of ground line 8. Connection surface 31a is, for example, a flat surface extending along the X direction and the Z direction. Coupled portion 32 couples end portion 31 and ground bar 4. Coupled portion 32 extends in a direction inclined with respect to both the Y direction and the Z direction when viewed along the X direction. Coupled portion 32 is connected to ground bar 4. Thus, the plurality of terminals 3 are integrated in ground bar 4. Thus, ground lines 8 are electrically connected to each other via the plurality of terminals 3 and ground bar 4. In this way, each of the plurality of ground lines 8 is electrically connected to the ground via the plurality of terminals 3 and ground bar 4. As a result, since shield layer 6b, the plurality of terminals 3, and the plurality of ground lines 8 are electrically connected to the ground in common, the impedance of electric connector 1 can be stabilized.

FIG. 3 shows a cross section of connection assembly 100 in a plane perpendicular to a center axis C5 of the plurality of conductors 5. As shown in FIG. 3, a cross section of the plurality of conductors 5 (hereinafter, referred to as “conductor cross section”) in a plane perpendicular to center axis C5, only the plurality of ground lines 8 among the plurality of signal lines 7 and the plurality of ground lines 8 each include at least a first flat portion 8a on a surface 81. Surface 81 may be a side surface of the outer surface of conductor 5, which extends from the end surface of conductor 5 along the extending direction of conductor 5.

Center axis C5 is an axis line passing through the center of conductor 5. The conductor cross section in the plane perpendicular to center axis C5 is a conductor cross section obtained by cutting any position along the extending direction of center axis C5 of conductor 5 at a plane perpendicular to center axis C5. Any position along the extending direction of center axis C5 of conductor 5 may be, for example, any part of first portion 51a, second portion 51b, and coupled portion 51c, or may be any part of conductor 5 inside covering portion 6.

The plurality of signal lines 7 do not have a flat portion on surface 81 in the conductor cross section. As an example, each of the plurality of signal lines 7 has a circular shape in the conductor cross section. On the other hand, each of the plurality of ground lines 8 includes, for example, first flat portion 8a, a second flat portion 8b, a third flat portion 8c, and a fourth flat portion 8d on surface 81 in the conductor cross section. Each of the plurality of ground lines 8 has a rectangular shape in the conductor cross section. First flat portion 8a, second flat portion 8b, third flat portion 8c, and fourth flat portion 8d are continuously formed, for example, from the end surface of conductor 5 to the other end surface on the opposite side. That is, first flat portion 8a, second flat portion 8b, third flat portion 8c, and fourth flat portion 8d are formed over the entire region in the extending direction of conductor 5 (that is, the direction in which center axis C5 extends). First flat portion 8a, second flat portion 8b, third flat portion 8c, and fourth flat portion 8d may be formed only in a partial region (for example, a part or the whole of end portion 51) in the extending direction of conductor 5.

Each of first flat portion 8a and second flat portion 8b is, for example, a flat surface intersecting the Y direction and faces away from each other along the Y direction. As an example, each of first flat portion 8a and second flat portion 8b extends along the X direction and the Z direction, and is disposed in parallel along the Y direction. First flat portion 8a faces ground bar 4 or the plurality of terminals 3 in the Y direction. First flat portion 8a is connected to connection surface 31a via, for example, solder. Second flat portion 8b faces electrode 9 on main surface 10a of substrate 10 in the Y direction. Second flat portion 8b is connected to electrode 9 via, for example, solder. The connection between connection surface 3la and first flat portion 8a and the connection between electrode 9 and second flat portion 8b are not limited to the solder connection, and may be other connections such as crimping or welding (for example, laser welding, thermal welding, or the like). First flat portion 8a may be in direct contact with connection surface 31a without solder. Second flat portion 8b may be in direct contact with electrode 9 without the solder. For example, second flat portion 8b may be connected to electrode 9 by a pressing member that presses the plurality of conductors 5 toward substrate 10.

Each of third flat portion 8c and fourth flat portion 8d is, for example, a flat surface intersecting the X direction and faces away from each other along the X direction. As an example, each of first flat portion 8a and second flat portion 8b extends along the Y direction and the Z direction, and is disposed in parallel along the X direction. The length between first flat portion 8a and second flat portion 8b in the Y direction is equal to the length between third flat portion 8c and fourth flat portion 8d in the X direction. That is, in the conductor cross section, the width of ground line 8 in the Y direction is the same as the width of ground line 8 in the X direction.

The expression “ground line 8 includes the first flat portion on surface 81 in the conductor cross section” means that surface 81 of ground line 8 is represented by at least one straight line portion in the conductor cross section. For example, as described above, in the conductor cross section, surface 81 of ground line 8 may be represented by only one or more straight line portions. For example, in the conductor cross section, surface 81 of ground line 8 may be represented by a straight line portion and a curved portion. Further, the expression “signal line 7 does not have a flat portion on surface 81 in the conductor cross section” means that surface 81 of signal line 7 is represented only by a curved portion in the conductor cross section.

Next, effects obtained by electric connector 1, connection assembly 100, and cable 2 according to the embodiment will be described.

Electric connector 1 of the embodiment includes a plurality of terminals 3 arranged in parallel along the X direction in such a manner that each of the plurality of terminals 3 faces a corresponding one of end portions 51 of the plurality of ground lines 8, and electrically connecting each of the plurality of ground lines 8 to the ground. In this case, it is possible to suppress crosstalk in which a part of the electromagnetic wave generated by a signal transmitted to signal line 7 goes around another signal line 7 through an air layer. For example, when a part of the electromagnetic wave generated by the signal transmitted to signal line 7B propagates so as to go around ground line 8B on the side opposite to substrate 10, the part of the electromagnetic wave is shielded by terminal 3B (see FIG. 1). Thus, the part of the electromagnetic wave generated by the signal transmitted to signal line 7B cannot go around signal line 7C. Further, in the conductor cross section, only the plurality of ground lines 8 among the plurality of signal lines 7 and the plurality of ground lines 8 each include first flat portion 8a on surface 81. Each of the plurality of terminals 3 includes connection surface 31a connected to first flat portion 8a. When ground line 8 includes first flat portion 8a on surface 81 as described above, the bonding strength between ground line 8 and terminal 3 can be improved, and thus the plurality of ground lines 8 can be stably connected to the ground via the plurality of terminals 3. For example, since the solder or terminal 3 can be stably disposed on first flat portion 8a, first flat portion 8a can be stably physically in contact with terminal 3 or can be stably connected to connection surface 31a of terminal 3 via the solder. In addition, when ground line 8 includes first flat portion 8a on surface 81, the cross-sectional area of ground line 8 can be increased as compared to when ground line 8 does not include first flat portion 8a on surface 81 (for example, a ground line having a circular shape), thereby reducing electrical resistance. Furthermore, since signal line 7 does not include a flat portion on surface 81, it is possible to suppress the formation of a corner portion on surface 81 of signal line 7, and thus it is possible to suppress the deterioration of the high-frequency characteristics due to the skin effect. Thus, according to electric connector 1 of the embodiment, it is possible to improve the communication performance of the signal propagating through signal line 7 or the like.

As in the embodiment, the plurality of signal lines 7 may include signal line 7A and signal line 7B adjacent to each other. The plurality of ground lines 8 may include ground line 8A and ground line 8B disposed so as to sandwich signal line 7A and signal line 7B in the X direction and electrically connected to each other via the plurality of terminals 3. In this case, signal line 7A and signal line 7B can constitute a differential signal line. Thus, since the currents flowing through signal line 7A and signal line 7B are in opposite phases, for example, a part of the electromagnetic wave that goes around ground line 8A from signal line 7A and a part of the electromagnetic wave that goes around ground line 8B from signal line 7B can be canceled out by each other. For example, when a part of the electromagnetic wave generated by the signal transmitted through signal line 7A reaches ground line 8A and a part of the electromagnetic wave generated by the signal transmitted through signal line 7B reaches ground line 8B, the two electromagnetic waves cancel each other out at the plurality of terminals 3 (and ground bar 4). In addition, when ground bar 4 is disposed on surface 62 of or inside covering portion 6, the distance between ground bar 4 and the plurality of conductors 5 is reduced, compared to when ground bar 4 is disposed outside of cable 2. Thus, the two electromagnetic waves can cancel each other out more effectively. As a result, the communication performance of the signal propagating through signal line 7 or the like can be further improved.

As in the embodiment, ground bar 4 disposed on surface 62 of or inside covering portion 6 and connected to the ground may be provided. The plurality of ground lines 8 may be connected to ground bar 4 via the plurality of terminals 3. In this case, the ground can be stabilized by connecting the plurality of terminals 3 to ground bar 4 and integrating them. Thus, it is possible to reduce the influence of crosstalk and improve the communication performance of a signal propagating through signal line 7 and the like. Furthermore, in the embodiment, shield layer 6b of covering portion 6 is connected to and integrated with ground bar 4, and thus the ground can be further stabilized.

In addition, when ground bar 4 is disposed on surface 62 of covering portion 6, a part of the electromagnetic wave generated by the signal transmitted to signal line 7 can be shielded from entering another signal line 7 by ground bar 4. For example, a part of electromagnetic waves generated by the signal transmitted through signal line 7B can be shielded from going around signal line 7C by ground bar 4 (see FIG. 1). Thus, it is possible to more effectively reduce crosstalk in which a part of electromagnetic wave generated by the signal transmitted through signal line 7 goes around other signal lines 7.

As in the embodiment, each of the plurality of ground lines 8 may include, on surface 81, a second flat portion 8a facing away from the first flat portion 8b along the Y direction in the conductor cross section. For example, when electric connector 1 is disposed on main surface 10a of substrate 10, second flat portion 8b of each of the plurality of ground lines 8 is connected to electrode 9 of main surface 10a, thereby improving the bonding strength between ground line 8 and terminal 3 in first flat portion 8a and also improving the bonding strength between ground line 8 and electrode 9 of substrate 10 in second flat portion 8b. Thus, the electrical connection between terminal 3, ground line 8, and electrode 9 of substrate 10 can be stabilized.

As in the embodiment, each of the plurality of ground lines 8 may include, on surface 81, third flat portion 8c and fourth flat portion 8d that face away from each other along the X direction in the conductor cross section. In this case, for example, as compared with a case where ground line 8 includes a curved surface bulging toward both sides in the X direction in surface 81, the interval between ground lines 8 adjacent to each other can be made constant, and thus, the variation of the impedance can be suppressed. As a result, it is possible to suppress deterioration of a signal due to the fluctuation in impedance.

As in the embodiment, each of the plurality of signal lines 7 may have a circular shape in the conductor cross section. In this case, it is possible to more effectively suppress the deterioration of the high-frequency characteristics due to the skin effect in the plurality of signal lines 7.

The electric connector, the connection assembly, and the cable of the present disclosure are not limited to the above-described embodiments, and various modifications can be made.

In the above embodiment, in the conductor cross section, the width of ground line 8 along the Y direction is the same as the width of ground line 8 along the X direction, but is not limited to this.

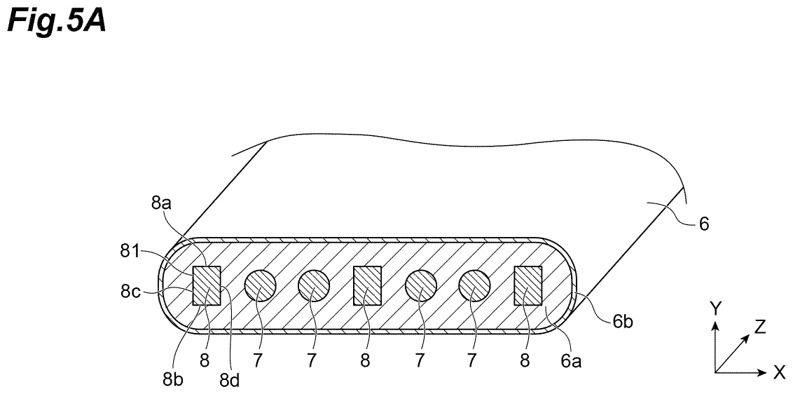

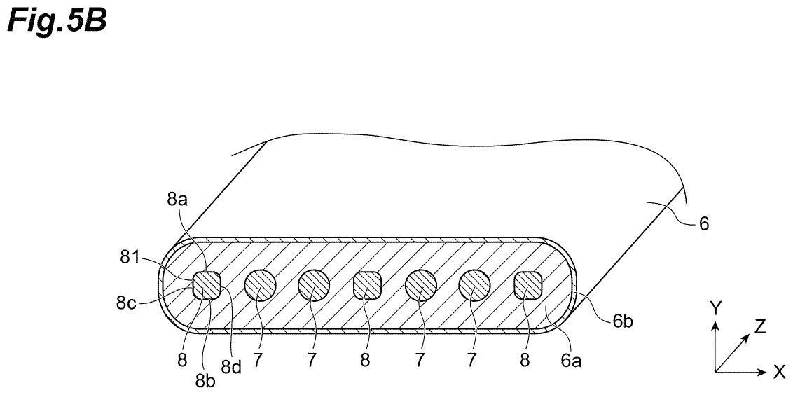

FIG. 5A is a cross-sectional view of a cable included in a connection assembly according to a first modification. As shown in FIG. 5A, in the conductor cross section, the width of ground line 8 along the Y direction may be larger than the width of ground line 8 along the X direction. In other words, the length between first flat portion 8a and second flat portion 8b in the Y direction may be longer than the length between third flat portion 8c and fourth flat portion 8d in the X direction. That is, ground line 8 may extend along the Y direction in the conductor cross section. The width of ground line 8 along the Y direction may be larger than the width of signal line 7 along the Y direction, for example. When the cross section of ground line 8 extends in the Y direction as described above, ground line 8 can effectively shield the electromagnetic wave that goes around from one signal line 7 to another signal line 7 with ground line 8 interposed therebetween. Thus the crosstalk between these signal lines 7 can be reduced. Further, when the cross section of ground line 8 extends in the Y direction, the cross-sectional area of ground line 8 can be increased, and thus electrical resistance can be reduced. As a result, the communication performance of the signal propagating through signal line 7 or the like can be further improved.

FIG. 5B is a cross-sectional view of a cable included in a connection assembly according a second modification. As shown in FIG. 5B, in the conductor cross section, a corner portion formed between first flat portion 8a and third flat portion 8c, between third flat portion 8c and second flat portion 8b, between second flat portion 8b and fourth flat portion 8d, or between fourth flat portion 8d and first flat portion 8a may be crushed or rounded. In this case, the cross-sectional area of ground line 8 can be adjusted in the conductor cross section, and the impedance in electric connector 1 can be adjusted.

In the above embodiment, end portions 51 of the plurality of conductors 5 extend along the Z direction, then bend toward the XZ plane, and extend to the plurality of electrodes 9 on main surface 10a of substrate 10. However, it is only required that end portions 51 extends from end face 61 to electrodes 9. For example, end portion 51 may extend only along the Z direction.

In the above embodiment, ground bar 4 is disposed on surface 62 of or inside covering portion 6, but is not limited thereto. For example, ground bar 4 may be disposed on another member such as main surface 10a of substrate 10.

In the above embodiment, electric connector 1 has ground bar 4 separately from shield layer 6b. However, ground bar 4 may be constituted by shield layer 6b itself or may be integrated with shield layer 6b. In this case, coupled portion 32 of terminal 3 is electrically connected to shield layer 6b as a conductive member.

What is claimed is:

1. An electric connector comprising:
a cable including a plurality of conductors and a covering portion, the plurality of conductors being arranged side by side and including a plurality of signal lines and a plurality of ground lines, the covering portion being configured to cover the plurality of conductors such that an end portion of each of the plurality of conductors is exposed; and
a plurality of terminals arranged side by side along an aligned direction of the plurality of conductors in such a manner that each of the plurality of terminals faces a corresponding one of the end portions of the plurality of ground lines, the plurality of terminals electrically connecting each of the plurality of ground lines to a ground,
wherein, in a cross section of the plurality of conductors in a plane perpendicular to a center axis of the plurality of conductors, only the plurality of ground lines among the plurality of signal lines and the plurality of ground lines each include a first flat portion on a surface of each of the plurality of ground lines, and
each of the plurality of terminals includes a connecting portion connected to the first flat portion.

2. The electric connector according to claim 1,
wherein the plurality of signal lines includes a first signal line and a second signal line adjacent to each other, and
the plurality of ground lines includes a first ground line and a second ground line that are disposed so as to sandwich the first signal line and the second signal line in the aligned direction and are electrically connected to each other via the plurality of terminals.

3. The electric connector according to claim 1,
wherein the electric connector includes a conductive member disposed on a surface of or inside the covering portion and connected to the ground, and
the plurality of ground lines is connected to the conductive member via the plurality of terminals.

4. The electric connector according to claim 1,
wherein each of the plurality of ground lines further includes, on the surface, a second flat portion facing away from the first flat portion along a vertical direction perpendicular to the aligned direction in the cross section.

5. The electric connector according to claim 1,
wherein each of the plurality of ground lines further includes, on the surface, a third flat portion and a fourth flat portion that face away from each other along the aligned direction in the cross section.

6. The electric connector according to claim 1,
wherein, in the cross section, when a direction perpendicular to the aligned direction is defined as a vertical direction, a width of the ground line along the vertical direction is larger than a width of the ground line along the aligned direction.

7. The electric connector according to claim 1,
wherein each of the plurality of signal lines has a circular shape in the cross section.

8. A connection assembly comprising:
the electric connector according to claim 1; and
a substrate including a plurality of electrodes each connected to a corresponding one of the plurality of conductors, and being provided with the electric connector.

9. A cable comprising:
a plurality of conductors arranged side by side and including a plurality of signal lines and a plurality of ground lines; and
a covering portion configured to cover the plurality of conductors such that an end portion of each of the plurality of conductors is exposed,
wherein, in a cross section of the plurality of conductors in a plane perpendicular to a center axis of the plurality of conductors, only the plurality of ground lines among the plurality of signal lines and the plurality of ground lines each include a first flat portion on a surface of each of the plurality of ground lines.

10. The cable according to claim 9,
wherein the plurality of signal lines includes a first signal line and a second signal line adjacent to each other, and
the plurality of ground lines includes a first ground line and a second ground line that are disposed so as to sandwich the first signal line and the second signal line in a aligned direction of the plurality of conductors and are electrically connected to each other.
